(19) United States
(12) Patent Application Publication
(10) Pub. No.: US 2006/0021302 A1
(43) Pub. Date: Feb. 2, 2006

(54) Anti-microbial air filter

(76) Inventor: Bobby Lynn Bernard, Rogersville, TN (US)

Correspondence Address: Mark L. Davis, P.O Box 9293, Gray, TN, 37615-9293, US

(21) Appl. No.: 11/189,525

(22) Filed: Jul. 26, 2005

Related U.S. Application Data
(60) Provisional application No. 60/592,727, filed on Jul. 30, 2004.

(51) Int. Cl. B01D 45/00

(52) U.S. Cl. 55/282

(57) ABSTRACT

A filtration device useful as a personal filtration mask, home air filter, air moving equipment filter, and breathing air compressor intake filters. The filtration medium includes from 0.001 to 100% of at least one prophylactic compound. A method for reducing the amount of bacteria in a fluid stream is described using the filter device of the present invention.

### CROSS REFERENCE TO RELATED APPLICATIONS

Benefit is claimed to the earlier filed application having U.S. Ser. No. 60/592,727 filed Jul. 30, 2004, the entire disclosure of which is incorporated herein by reference.

### BACKGROUND OF THE INVENTION

The present invention relates to a filter useful for reducing the number of microbial organisms in an air stream. More particularly, the present invention relates to an air filter that incorporates at least one prophylactic compound useful in reducing the number of microbial organisms.

During the course of a lifetime, a person inhales a large volume of air into their lungs. Along with the air comes all manner of airborne contaminants, such as pollen, dust, dander, fumes, bacteria and viruses. For the most part, the lungs, bronchial tubes and nasal passages have protective means for filtering or handling benign airborne materials that are drawn into the lungs with the air. However, infectious organisms such as viruses and bacteria typically penetrate the mucous membranes and enter into the body. Subsequently, the bacteria and virus may produce illnesses or toxic effects that require specialized medication and/or hospitalization.

Another, problem that leads to a low quality of breathable air is the construction of buildings, such as homes and offices. With ever increasing costs for heating and ventilation, the move has been to make the buildings ever more energy efficient. This results in a reduced amount of inside air being exchanged with fresh outside air. This lowers the inside air quality, increases the concentration of airborne contaminants and increases airborne infectious viral and bacterial populations contained inside the structures. Such increased contaminants may result in what has become known as sick building syndrome.

Viral and bacterial infections of individuals and particularly immuno-compromised individuals, such as premature infants, persons with severe burns, persons with cell-mediated immunity, patients receiving immunosuppressive therapy, patients suffering from acquired immunodeficiency syndrome (AIDS) and the like, are always a concern. Generally, it is known that individuals may reduce the risk of viral and bacterial infection by taking individual responsibility and simple preventive measures, such as washing one's hands after contact with an infected surface, before handling food or touching any open wound. However, in the case were such infectious organisms are airborne, such preventive measures have limited success. Typically, the person comes in contact with the infectious organism by breathing and the organism invades the mucosal membranes of the nasal or bronchial passages.

Currently, treatment of a patient for an illness brought on by the organism or its biotoxin(s) is limited to post-exposure prophylactic measures where the patient ingests, breathes, injects or topically applies a suitable absorptive antibiotic designed to prevent the spread of the infectious organism. However, a problem with such post-exposure measures is that many ailments currently have no known effective treatment medications or the organisms have developed a resistance to the preferred medication or antibiotics. As used herein, the term “prophylactic” means the treatment for infectious organism which prevents a subclinical infection or infectious organism count from developing into a clinically recognizable infection. The term “prophylactic compound” means: a) a medicament or other compound useful in the general or specific treatment of clinically recognizable infection; or b) a compound that is now or later recognized as effectively inhibiting the growth of or effectively neutralizes an infectious agent or organism and which is safe for human contact in concentrations sufficient to reduce or eliminate specific or general viral and/or bacterial airborne populations. Thus, it would be beneficial if such air-borne infectious organisms could be removed, reduced, or neutralized in the air before the organism is inhaled. The terms “neutralize” or “neutralizing” are used interchangeably herein to mean that the infectious agent is: a) physically bound or immobilized; or is b) rendered inactive or non-infectious, such as, for example, by killing the infectious agent, biologically or chemically altering the infectious agent or coating at least a portion of infectious agent with a compound that inactivates one or more sites that may bind with or invade human cells or cellular membranes.

Removing such infectious organisms from the air is more difficult than originally thought. Air moving equipment for homes, hospitals, business, airplanes, and the like is designed to move a specific amount of air in order to operate efficiently, keep the air filtered, and maintain the indoor environment to a predetermined temperature, humidity or quality. Typically, air moving equipment includes a squirrel-cage blower attached to appropriately sized motor. The inside air is filtered and collected at specific locations, such as a cold air return conduits, and is drawn into the blower. The blower forces the air through a heating or cooling exchanger to raise or lower the temperature of the air. The treated air is then distributed throughout the building via a system of conduits or ducts. The inside cooler air is again collected and the process repeated. Fresh air is introduced as people, pets, and the like enter and exit the structure, through openings, such as cracks around windows and doors, and through specialized equipment designed for such air exchange operations.

Air filters, on the other hand, are designed to remove airborne dust and dander having particle sizes of from about 5 to about 100 microns. Better air filters are designed to remove, in addition to dust and dander, such contaminants as pollen, and to a limited degree mold spores and fungi. Air filtration media generally relies on particle capture by contact with the filter media. This can occur by direct interception of the particle on the filter media or by attracting the particles to the media.

Viruses and bacteria generally have a size of from about 0.001 microns to about 5 microns. If the air filter media pores are sufficiently small, i.e., micropore, to remove the infectious organisms then the filter surface area would have to be prohibitively large to supply the blower with a sufficient air stream for heating or cooling. Another drawback is that higher capture efficiencies are typically realized at the expense of high pressure drops created by the filter media flow resistance. A micropore filter media would be susceptible rapid clogging as particles of dust, dander, mold and pollen would immediately plug the filter media micropores. This would shorten the filter's useful life and increase energy costs since the blower motor would have to operate longer to move the predetermined amount of air.

Accordingly, there is a need for an air filtration device that will reduce the number of microbial organisms in an air stream without: 1) substantially shortening the useful life of the filter; 2) increasing energy costs associated with moving the air; or 3) substantially restricting the flow of air through the filter media.

### SUMMARY OF THE INVENTION

Briefly, the present invention is directed to a filtration device having a biocidal filter media layer. In one embodiment, the filter media layer comprises at least one biocidal prophylactic compound. In another embodiment the prophylactic compound is adjacent to or interwoven with the filter media whereby a portion of the air passing through the filtration device contacts the prophylactic compound.

In one embodiment of the present invention the air filtration device further includes a frame member for stiffening or contouring the filter media layer.

It is an object of the present invention to provide an air filtration device that includes a prophylactic compound useful for effectively inhibiting the growth of or that effectively neutralizes an infectious agent.

It is another object of the present invention to provide an air filtration device that includes a prophylactic compound useful for effectively inhibiting the growth of or that effectively neutralizes a viral or bacterial infectious agent.

These and other objects and advantages of the present invention will become more apparent to those skilled in the art in view of the following description and the accompanying drawings wherein like parts and objects in the several views have similar reference numerals. It is to be understood that the inventive concept is not to be considered limited to the constructions disclosed herein but instead by the scope of the appended claims.

### BRIEF DESCRIPTION OF THE DRAWINGS

FIG. 1. is an enlarged cross-sectional view of the filter device of the present invention.

FIG. 2 is an enlarged perspective view of one embodiment of the present invention illustrating the prophylactic compound incorporated into the air filter media.

FIG. 3 is an enlarged perspective view of another embodiment of the present invention wherein the prophylactic compound is encapsulated in a pharmaceutically acceptable material on the air filter media.

### DETAILED DESCRIPTION OF THE INVENTION

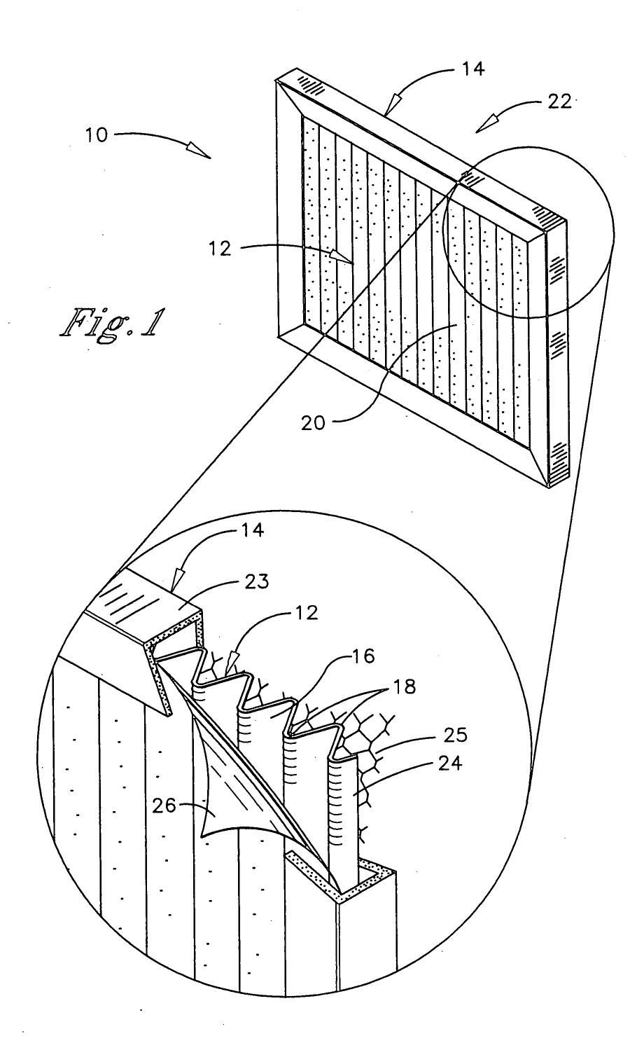

Referring now to the drawings, FIG. 1 shows a pleated filter element 10 having a porous filter media 12 contained within a retaining means 14. In one aspect of the present invention, the filter media 12 is a substantially planar surface. Desirably, the filter media 12 includes a plurality of adjacent opposed panels 16 arranged in an angular relationship that define a plurality of peaks or pleats 18 that produce ridges and valleys in the filter media 12. The filter media 12 has a front or outwardly facing region 20 disposed toward the environment and a back or inwardly facing region 22 disposed toward the end user. Air flowing through the filter element 10 enters in the front 20, passes through the filter media 12 and exits out the back 22.

The porous filter media 12 can be any filtration media known to those skilled in the filtration art, such as a fibrous material, an open-celled foam or porous membrane, a woven scrim, a non-woven fibrous mat, a perforated film or a combination thereof. The air filter media 12 can be constructed from a natural material, a synthetic materials or a combination thereof. The filter media 12 can be made of a wide variety of organic polymeric materials, including mixtures and blends. Suitable filter media includes a wide range of materials commercially available, such as: polypropylene, linear low density polyethylene, poly-1-butene, poly(4-methyl-1-pentene), polytetrafluoroethylene, polytrifluorochloroethylene, polyvinylchloride, polystyrene, polycarbonates, polyesters, and combinations thereof (including blends or copolymers). Preferred materials include polyolefins free of branched alkyl radicals and copolymers thereof. Particularly preferred materials include thermoplastic fiber such as polyethylene, polypropylene, and copolymers thereof. Other suitable materials include cellulose, rayon, acrylic, and modified acrylic, polyamide, polyimide fibers and fiber blends of different polymers.

Desirably, the filter media 12 is a mat of randomly oriented fibrous material having a fiber size of less than about 500 microns in diameter, and preferably less than about 100 microns. In a preferred embodiment, the filter media 12 is a nonwoven material formed in a web by conventional techniques known to those skilled in the art, such as by melt blowing, spunbonding, carding, air laying, and wet laying. Preferably the non-woven web is not highly consolidated by such methods as hydroentanglement, heat treating or thermomechanical bonding. The filter media 12 can have a wide variety of basis weights ranging from about 5 grams per square meter (g/m²) to about 1000 g/m² and more preferably from about 20 g/m² to about 200 g/m². The filter media 12 can have a thickness of from about 0.005 of an inch to about 5 inches. Preferably, the filter media 12 has a thickness of from about 0.1 of an inch to about 3 inches, and more preferably from about 0.25 of an inch to about 1.5 inches.

The filter media 12 can have a variety of configurations depending upon the predetermined end product use and filtration requirements for the given application. For example, the filtration media can have discrete channels, open channels, “V” shaped channels, a stacked configuration and be bonded or unbonded. As illustrated, the filter media 12 has ordered fluid pathways defined by a plurality of flow channels. The flow channels are defined by a series of opposing side walls 16 which in turn define peaks or pleats 18 of the filter media 12. The peaks 18 may be separated by a planar floor or by sub-peaks forming sub-channels. The aggregation of the peaks collectively form a pleated fibrous mat. While any pleated fibrous filter media may be used, a preferred filter media is an electrostatically charged web transforming the web into an electret. An electret is generally a piece of dielectric material that exhibits an electrical charge that persists for extended time periods. Electret chargeable materials include non-polar polymers such as polytetrafluoroethylene (PTFE) and polypropylene. Generally, the net charge on an electret is zero or close to zero and its fields are due to charge separation and not caused by a net charge. Through the proper selection of materials and treatments, an electret can be configured that produces an external electrostatic field. Several methods are commonly used to charge dielectric materials, any of which may be used to charge the filter media layer used in the present invention, including corona discharge, heating and cooling the material in the presence of a charged field, contact electrification, spraying the web with charged particles, and wetting or impinging a surface with water jets or water droplet streams. Another type of treatment available is the use of fluorochemical additives in the form of material additions or material coatings which can improve a filter layer's ability to repel oil and water, as well as enhance the ability to filter oily aerosols. Examples of such additives are found in U.S. Pat. No. 6,398,847 issued on Jun. 4, 2002 to Jones et al.

The filter media 12 may be relatively stiff and self-supporting web or relatively soft and non self-supporting. By “self-supporting” it is meant that the media, with or without a supporting structure, generally maintains its shape when subjected to an air stream. Thus, whether the media is self-supporting or not depends on the physical properties of the media itself, the geometry or construction of the media, and the conditions to which the media is subjected in a particular end use application. Generally, a stiff self-supporting media preferably has a Gurley stiffness of greater than 50 milligrams for a sample size having a width of 2 inches and a length of 1.5 inches, and a soft non self-supporting media preferably has a Gurley stiffness of less than 30 milligrams for a sample size having a width of 2 inches and a length of 1.5 inches. For media having stiffness values between these values, whether the media is self-supporting depends on the construction of the media and on the end use application. Desirably, the stiffing means 14 of the filter device 10 includes a supporting member 23 such as a frame which extends around and defines a peripheral edge 24 of the filter media 12. Depending upon the type of filter media 12 utilized, it may be necessary or expedient that the stiffing means 14 to further include a mesh type backing wire or grid 25 to assist in retaining the filter media 12 in the frame.

The filter device includes a biocidal prophylactic compound 26 incorporated into the air filtration device 10 in a manner that a portion of the air passing through the filtration device contacts the prophylactic compound 26. Referring to FIG. 2, in one embodiment, the filter media 12 comprises fibrous and/or particles of the prophylactic compound 26. Alternatively, the filter media 12, may be used as a substrate for the prophylactic compound 26 by incorporating the prophylactic compound 26 onto an outer surface 28 of the filter media 12. As seen in FIG. 1, one skilled in the art would understand that the prophylactic compound may also be incorporated into the filter device as a separate layer and, relative to the air flow direction, may be placed either before or after the filter media 12. The material utilized as a separate substrate for the prophylactic compound can be any material that is suitable for the intended use of the end product, such as for example, a woven or non-woven web, a perforated film, foam or porous membrane.

The prophylactic compound, which can be incorporated into the filter 10 as a separate layer 26 (as seen in FIG. 1), or as part of the filter media 12 (as seen in FIG. 2), can be any medicament or other microbiocidal compound: 1) useful in the general or specific treatment of clinically recognizable infection; and/or 2) that is now or later recognized as effectively inhibiting the growth of or effectively neutralizing the infectious agent and which is safe for human contact in concentrations sufficient to effectively reduce or eliminate specific or general viral and/or bacterial airborne populations. Such compounds may be naturally occurring, synthetically derived or combinations thereof. Non-limiting examples of such materials include water soluble coenzymes; oil soluble coenzymes; amino acid type surfactants; plant extract derived from Alium cepa; anitbiotics, biocidal metals and metal containing compounds, organosilicone quaternary ammonium salts; sulfated polysaccharides; aliphatic and aromatic fatty acids having from 6 to 20 carbon atoms; cellulose or cellulose derivatives, and mixtures thereof. As used herein, “cellulose” or “cellulose derivatives” means cellulose or a cellulose derivative having partial or total substitution of the free hydroxyl functions preferably with moieties selected from the formula —OYR wherein:
R is selected from: a) hydrocarbon groups with linear or branched chains, saturated or unsaturated, or saturated or unsaturated cyclic moieties, containing from 1 to 50 carbon atoms which may optionally contain in their chains one or more aromatic groups and/or one or more heteroatoms chosen from O, N, P, S, or Si; or b) cyclic aromatic compounds having from 6 to 14 carbon atoms that can optionally be substituted with —(C═O)OR₂, —SO₂ R₂, —CO—N(R₂)₂, —OR₂, —N(R₂) 2, —SR₂, where R₂ is selected from the group consisting of hydrogen or linear, branched or cyclic hydrocarbon groups having from 1 to 50 carbon atoms; and
Y is a single bond or divalent linking group. As used herein the term “divalent linking group” means a spacer organic group forming a bridge between the oxygen atom and R group and preferably is selected from —(C═O), —(C═O)O—, —SO₂—, —CO—NH—, or —CO—NR′—, wherein R′ is an alkyl radical having from 1 to 4 carbon atoms. Desirably, the cellulose or cellulose derivatives are selected from chosen from acetates, propionates, butyrates, isobutyrates, acetobutyrates, acetopropionates of cellulose and their mixtures. More preferably, the cellulose derivatives are selected from cellulose acetate, cellulose acetate phthalate (CAP); hydroxypropyl methylcellulose phthalate (HPMCP) and mixtures thereof.

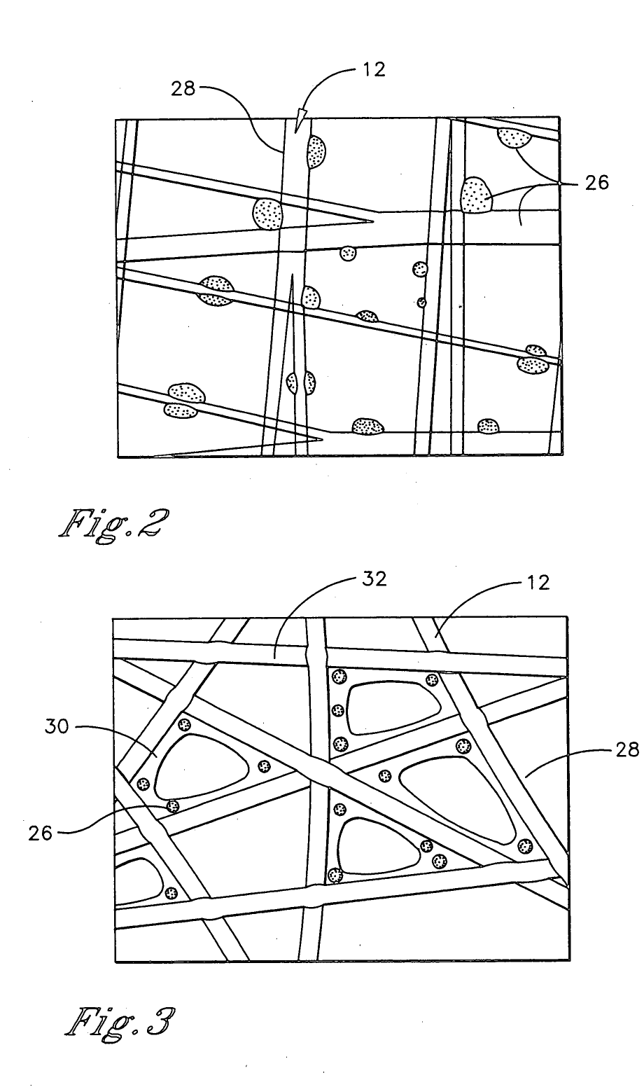

Referring to FIG. 3, the prophylactic compound 26 can be incorporated onto the air filtration device 10 either alone or in combination with a pharmaceutically acceptable carrier or diluent 30. In the case were the prophylactic compound 26 is selected from cellulose acetate, cellulose acetate phthalate, hydroxypropyl methylcellulose phthalate or mixtures thereof, the CA, CAP and/or HPMCP may be prepared as suspension of micronized particles and may further contain a water miscible, non-solvent such as glycerol. Desirably, the micronized CA, CAP or HPMCP is prepared as a slurry by dispersing the prophylactic compound in a suitable solvent or aqueous media prior to contacting the substrate. The substrate and micronized CA, CAP or HPMCP are placed in contact such that at least a portion of the micronized CA, CAP or HPMCP is affixed to a portion of the porous substrate. The CA, CAP or HPMCP can be micronized using procedures known to those skilled in the art and generally CAP is available from FMC Corporation under the trade name AQUATERIC. Desirably, the micronized CA, CAP or HPMCP have an mean particle diameter of less than about 35 microns, and preferably less than about 20 microns, more preferably less than about 10 microns and most preferably less than about 5 microns.

Alternatively, the CA, CAP or HPMCP can be formed into fibers 32 having a thickness of from about 0.001 microns to about 1000 microns, and preferably from about 0.0025 microns to about 100 microns which is then either incorporated into the web of fibrous filter media 12 or formed into a separate layer as described above. The CA, CAP or HPMCP web can have a basis weight of from about 20 g/m² to about 200 g/m² and preferably is from about 5 g/m² to about 50 g/m² and more preferably is from about 5 g/m² to about 15 g/m².

Additionally, a plasticizer can be used to improve the water resistance of the CAP. Suitable plasticizers include aceylated monoglyceride, butyl phthalylbutyl glycolate, dibutyl tartrate; diethyl phthalate, dimethyl phthalate, ethyl phthalyethyl glycolate, glycerin, propylene glycol, triacetin, triacetin citrate, tripropionin and mixtures thereof.

One skilled in the art will recognize that the amount of prophylactic compound incorporated into the filter device is dependent upon the desired efficacy of the filter device. It is understood that the biocidal effect of the prophylactic compound does not need to be 100 percent effective on a single pass since the inside air is circulated through the filter device multiple times over the life of the filter. Desirably, the amount of prophylactic compound incorporated is from about 0.001 to about 100 weight %, based on the total weight of the filter media 12 and prophylactic compound 26. Preferably, the amount of prophylactic compound 26 incorporated is from about 0.01 weight % to about 20 weight % and more preferably from about 0.1 weight % to about 10 weight %, based on the total weight of the filter media 12 and prophylactic compound 26.

Cellulose acetate phthalate and hydroxypropyl methylcellulose phthalate are both widely used in oral pharmaceutical applications and are generally regarded as non-toxic and free of adverse effects. Cellulose acetate phthalate is generally prepared by reacting the partial ester of cellulose with phthalic anhydride in the presence of an organic acid, such a acetic acid. Hydroxypropyl methylcellulose phthalate is generally prepared by the esterification of hydroxypropyl methylcellulose with phthalic anhydride. CAP is available from Eastman Chemical Company, Kingsport, Tenn. and HPMCP is available Shasun, India.

One skilled in the art will recognize that the filtration device of the present invention may include other materials, such as a washable porous pre-filter layer having a pore size adapted to capture airborne particles having an average diameter substantially greater than the filter media 12 so that the life of the filter media is substantially improved. Optionally, the filtration device may also include a layer of activated charcoal that will absorb chemical or malodorous vapors from the air prior to the air contacting the prophylactic compound.

In use, the air filtration device 10 of the present invention can be used for such applications, for example, as a personal filtration mask; home and/or business furnace filter; filters for air moving equipment in hospitals, nursing homes; breathing air compressor intake filter, and closed quarters applications such as airplane breathing air filters, and submarine breathing air filters to name just a few.

Another embodiment of the present invention, is a method for reducing an amount of bacteria in a fluid stream. The method includes providing a filter device having a filter media comprising at least one prophylactic compound as described above and passing the fluid stream through the filter device so that at least a portion of the fluid stream contacts the prophylactic compound. In a preferred embodiment, at least a portion of the fluid stream is recirculated through the filter device. Desirably, the amount of bacteria present in the recirculated fluid stream is less than the amount of bacteria that would be present in a recirculated fluid stream absent the prophylactic compound from the filter device.

The present invention is illustrated in greater detail by the specific examples presented below. It is to be understood that these examples are illustrative embodiments and are not intended to be limiting of the invention, but rather are to be construed broadly within the scope and content of the appended claims. All parts and percentages in the examples are on a weight basis unless otherwise stated.

In the examples below, the specified test material was assessed for antimicrobial effectiveness after inoculation with a test organism and then evaluated to determine the percent reduction of the test organism after specified exposure periods. The antimicrobial effectiveness of the present invention was evaluated using test method 100-2004 as specified by the Technical Manual of the American Association of Textile Chemists and Colorists, (AATCC) vol. 78, 2003 as modified herein.

The sample filter material for Examples 1-22 is as specified below. Methods and procedures for preparing cellulose acetate and cellulose acetate phthalate are well known to those skilled in the art. For all the examples, except for Examples 11 and 22, the amount of water in the fiber dope was 1 weight % at the time of spinning. For Examples 11 and 22 the amount of water in the fiber dope was 3 weight % at the time of spinning. However, from the data presented below, this did not appear to affect the biocidal filter efficiency.

The cellulose acetate phthalate (CAP) fibers were produced from powder cellulose acetate phthalate NF (available from Eastman Chemical Company, Kingsport, Tenn.). The dry powder was dissolved in acetone or acetone/water and spun into fibers having a denier of 4.3, 5.1 and 6.1 on an apparatus as described in U.S. Pat. No. 3,077,633. As used herein, the term “denier” is a unit of weight measurement equal to one gram per 9000 meters of length.

The fibers were cut into ⅛ to ¼ in size length by hand using a manual cutting board, and separated into individual fibers by mixing in a Warner Blender using a non-cutting blade.

In preparing the fibers into a filter, 2.4 grams of the specified fiber are weighed into a container and diluted with demineralized water. The filters were then produced as described in the TAPPI method T 205 om-88 (1988), beginning with procedure 7.2 “sheetmaking”, the entire disclosure of which is incorporated herein by reference. The filters were then dried as described in Section 7.6 at 200° C. The resulting filters were approximately 6 inches (15.2 cm) in diameter and about 0.45 to 0.50 mm thickness. The filters were also washed free of any remaining residual acetone from the spinning process.

The specified micronized powder was produced by cryogenic grinding the material to an average diameter of less than 22 micron. The filters containing micronized powder were prepared by adding the powder to the water wet filter prior to drying. From 0.45 of a gram to about 0.50 of a gram of micronized powder was added to each filter containing the micronized powder. The micronized powder was thermally fused to the fibers by hot pressing the filter at a temperature of 180° C. to 200° C. for 30 minutes using an Emerson Speed Dryer, Model 135, available from Emerson Apparatus of Portland, Me.

Examples 1, 6, 12 and 17 were composed of cellulose acetate phthalate (CAP) fibers having a denier of 4.3 and approximately one-eighth (0.32 cm) to one-quarter (0.64 cm) of an inch in length. The fibers are available from Eastman Chemical Company, Kingsport, Tenn., United States of America.

Examples 2 and 13 were composed of cellulose acetate (CA) fibers having a denier of 4.3 and approximately one-eighth (0.32 cm) to one-quarter (0.64 cm) of an inch in length. The fibers are available from Eastman Chemical Company, Kingsport, Tenn., United States of America.

Examples 3, 9, 14 and 20 were composed of CAP fibers having a denier of 5.1 and approximately one-eighth (0.32 cm) to one-quarter (0.64 cm) of an inch in length. Intermixed with the CAP fibers was one-half of a gram of CAP powder having an average diameter of less than 22 microns. The CAP powder and fibers and are available from Eastman Chemical Company, Kingsport, Tenn., United States of America.

Examples 4 and 15 were composed of cellulose acetate fibers having a denier of 5.1 and approximately one-eighth (0.32 cm) to one-quarter (0.64 cm) of an inch in length. Intermixed with the cellulose acetate fibers was one-half of a gram of CAP powder having an average diameter of less than 22 microns. The CAP powder and fibers and are available from Eastman Chemical Company, Kingsport, Tenn., United States of America.

Examples 5 and 16 were composed of cellulose acetate fibers having a denier of 5.1 and approximately one-eighth (0.32 cm) to one-quarter (0.64 cm) of an inch in length. Intermixed with the cellulose acetate fibers was one-half of a gram of CA powder having an average diameter of less than 22 microns. The CA powder and fibers and are available from Eastman Chemical Company, Kingsport, Tenn., United States of America.

Examples 7 and 18 were composed of cellulose acetate phthalate fibers having a denier of 5.1 and approximately one-eighth (0.32 cm) to one-quarter (0.64 cm) of an inch in length. The fibers are available from Eastman Chemical Company, Kingsport, Tenn., United States of America.

Examples 8 and 19—were composed of cellulose acetate fibers having a denier of 5.1 and approximately one-eighth (0.32 cm) to one-quarter (0.64 cm) of an inch in length. The fibers are available from Eastman Chemical Company, Kingsport, Tenn., United States of America.

Examples 10 and 21 were composed of CAP fibers having a denier of 5.1 and approximately one-eighth (0.32 cm) to one-quarter (0.64 cm) of an inch in length. Intermixed with the CAP fibers was one-half of a gram of CA powder having an average diameter of less than 22 microns. The CA powder and fibers and are available from Eastman Chemical Company, Kingsport, Tenn., United States of America.

Examples 11 and 22 were composed of cellulose acetate phthalate fibers having a denier of 5.1 and approximately one-eighth (0.32 cm) to one-quarter (0.64 cm) of an inch in length. The fibers are available from Eastman Chemical Company, Kingsport, Tenn., United States, of America.

### EXAMPLES 1-11

The materials specified in Table 1 below were tested using 3 inch (7.6 cm) swatches of material exposed to an aerosol challenge of Staphylococcus aureus (ATCC #6538) which was repeatedly delivered to each test material over a two minute interval. The technique was modified from NLI standard BFE test to provide a challenge level of greater than 1×10⁶ colony forming units (CFU)/test article. The flow rate through the test article was maintained at 30 L/min. (1.1 cubic feet/min (CFM)). The face velocity, determined by the flow rate divided by the surface area, was maintained at 22 feet per minute (6.7 meters/min) unless specified otherwise.

In preparing the aerosol challenge of Staphylococcus aureus, 100 ml of soybean casein was inoculated with the bacterium and incubated at 37° C. (±2° C.) for 24 hours (±4 hours) with mild shaking. An amount of the inoculated soybean casein was diluted with peptone water to achieve an aerosol challenge concentration of greater than 1×10⁶ CFU. The challenge procedure was run as follows. Tubing was connected to a nebulizer and run through a peristaltic pump and into the challenge containing vessel. The lines to the nebulizer were then purged. The peristaltic pump was calibrated to deliver a constant challenge volume throughout the testing interval of 2 minutes. The test system was then allowed to equilibrate by running 2-3 blanks or unused control samples. Aliquots (30 mL) of peptone water were placed into all glass impinger (AGI) for a challenge titer run. The challenge titer was conducted under standard test conditions to determine the concentration of challenge aerosol droplets being delivered to the test articles. The flow rate of the challenge aerosol was maintained at 30 L/min. Using the nebulizer run through a peristaltic pump, aliquots of 30 ml of the inoculant were delivered to a test vessel for 1 minute and then turned off. The vacuum and pressure were allowed to run for 1 additional minute to clear the nebulizer and glass aerosol chamber of excess aerosol particles which afterwards was turned off. Standard plate count procedures were used to determine the titer of the control and a six-stage Andersen sampler was used to determine the mean particle size of the aerosol. To inoculate each test sample, the test sample was placed in the sample holder and the challenge procedure repeated except that no AGI was used. The titer of the AGI assay fluid was determined using standard plaque assay procedures.

Immediately following the 2 minute challenge, the test article was removed from the apparatus and placed in a closed containment vessel maintained at a temperature of 37° C. (±2° C.) for the designated time intervals. At each sampling interval, the inoculated swatch was placed in a flask containing approximated 100 mL of Letheen broth or other neutralizer(s) as needed. The flask was then manually shaken for approximately 1 minute. The neutralizer was serially diluted as necessary and evenly spread on a soybean casein digest agar (SCDA) plate using a sterile bent glass rod. The plates were then incubated at 37° C. (+2° C.) for 48-72 hours or until colonies could be counted.

A neutralization control was performed using uninoculated treated samples of each type in 100 mL aliquots. Approximately 100-10,000 CFU/mL of the Staphylococcus aureus was added to the extract fluid. The aliquots were then placed onto SCDA. Titer of the diluted Staphylococcus aureus was confirmed by adding the same volume of inoculum to a 100 mL bottle of Letheen broth or other neutralizer(s). The plate aliquots were than incubated at 37° C. (±2° C.) for 48-72 hours or until colonies could be counted.

The organism counts are specified below as CFU/specimen sample, i.e., test swatch. The percent reduction was then determined.

Positive and negative controls were for the test organism were also maintained. The positive control consisted of a 100 mL bottle of neutralizer spiked with the challenge organism. The negative control consisted of a sterile 100 mL bottle of neutralizer.

The results of the test are presented in Table I below. For Samples 1-4, the average control titer at time 0 was 1.4×10⁶ CFU and Samples 5-11 the average control titer at time 0 was 3.3×10⁶ CFU. Counts shown as approximate (˜) were taken from results where data was found outside the range of 25-250 CFU. Counts shown as (<) or (>) are dut to calculations which included at least one instance of less than 1 CFU recovery. Negative (−) percent reductions demonstrate an ending titer that was greater than the starting titer.

TABLE I

| Sample | Exposure | Recovered | Percent |
|---|---|---|---|
| ID | Interval (hrs.) | (CFU) | Reduction |
| 1 | 0 | 1.3 × 10⁶ | 11 |
| | 24 | 1.8 × 10⁴ | 98.7 |
| | 48 | ˜4.6 × 10⁴ | ˜96.8 |
| 2 | 0 | 1.4 × 10⁶ | 0 |
| | 24 | ˜1.5 × 10⁴ | ˜99.0 |
| | 48 | ˜2.4 × 10³ | ˜99.8 |
| 3 | 0 | 1.2 × 10⁶ | 15 |
| | 24 | ˜1.7 × 10⁴ | ˜98.8 |
| | 48 | <3.3 × 10² | >99.98 |
| 4 | 0 | 1.5 × 10⁶ | −5 |
| | 24 | 3.2 × 10⁴ | 97.7 |
| | 48 | 1.0 × 10⁴ | 99.3 |
| 5 | 0 | 1.3 × 10⁶ | 61 |
| | 24 | ˜1.8 × 10³ | ˜99.95 |
| | 48 | 1.2 × 10⁴ | 99.65 |
| 6 | 0 | 9.6 × 10⁵ | 71 |
| | 24 | ˜1.3 × 10⁴ | 99.62 |
| | 48 | <2.3 × 10³ | >99.3 |
| 7 | 0 | 1.4 × 10⁶ | 56 |
| | 24 | 9.4 × 10³ | 99.72 |
| | 48 | ˜5.1 × 10³ | ˜99.84 |
| 8 | 0 | 1.3 × 10⁶ | 61 |
| | 24 | ˜1.3 × 10³ | ˜99.96 |
| | 48 | ˜1.6 × 10³ | ˜99.95 |
| 9 | 0 | 1.1 × 10⁶ | 66 |
| | 24 | <2.0 × 10² | >99.99 |
| | 48 | ˜2.2 × 10³ | ˜99.93 |
| 10 | 0 | ˜6.5 × 10⁵ | ˜80 |
| | 24 | ˜4.7 × 10³ | ˜99.86 |
| | 48 | <2.0 × 10² | >99.99 |
| 11 | 0 | 1.2 × 10⁶ | 63 |
| | 24 | ˜6.4 × 10³ | ˜99.8 |
| | 48 | ˜9.0 × 10² | ˜99.97 |

### EXAMPLES 12-22

In Examples 12-22 the general procedures as set forth above for Examples 1-11 were followed, with the following exceptions. The challenge organism was bacteriophage phi-X174 (ATCC # 13706-B1) incorporated into Escherichia coli (E. coli C, ATCC #13706), a coliform as the host for the virus.

To prepare the phi-X 174 bacteriophage, approximately 100 mL of a nutrient broth was inoculated with E. coli C and incubated for about 6-18 hours at 37° C. (±2° C.) with stirring at about 200-250 rpm. A 1:100 dilution of the E. coli C culture was prepared and incubated at 37° C. (±2° C.) with stirring at about 200-250 rpm to grow a culture having a density of 2-4×10⁸ CFU/mL. This density corresponded to an optical density of 0.3-0.5 on a spectrophotometer at 640 nanometers.

The E. coli C bacterial culture was then inoculated with 5-10 mL of the bacteriophage phi-X174 so that the ratio of bacteriophage to bacteria cells would be between 0.1 to 2.0. The mixture was incubated for about 1 to 5 hours at 37° C. (±2° C.) with stirring at about 100-250 rpm. The mixture was then centrifuged at 10,000×G for about 20 to 40 minutes. The supernatant was then filtered through a sterile 0.2 m filter to remove the host cell debris and the phage stock was recovered. The test culture was then grown in a nutrient broth at 37° C. (±2° C.) for 18 to 24 hours.

Following the challenge procedure for Examples 1-11 above, various samples were subjected to a 2 minute challenge. Immediately following the 2 minute challenge, the test article was removed from the apparatus and placed in a closed containment vessel maintained at a temperature of 20-25° C. for the designated time intervals. At each sampling interval, the inoculated swatch was placed in a flask containing approximated 100 mL of Letheen broth or other neutralizer(s) as needed. The flask was then manually shaken for approximately 1 minute.

Plaque assay procedure was performed as follows. Two and one-half milliliters of molten top agar was dispensed into sterile test tubes and held at 45° C. (±2° C.) in a water bath. Aliquots of 0.5 mL of the appropriate dilutions were added to the top agar test tubes. One to two drops of the E. coli C bacterial culture was added to each test tube. The contents were mixed well and poured over the surface of bottom agar plates. The agar was allowed to solidify and then incubated at 37° C. (±2° C.) for 6-18 hours; the length of time depended on plaques large enough but not merging.

A neutralization control was performed using uninoculated treated samples of each type in 100 mL aliquots. Approximately 100-10,000 PFU/mL of the E. coli C bacterial culture was added to the extract fluid. Titer of the diluted E. coli C bacterial culture was confirmed by adding the same volume of inoculum to a 100 mL bottle of Letheen broth or other neutralizer(s).

The organism counts are specified below as PFU/specimen sample, i.e., test swatch. The percent reduction was then determined. The results of the test are presented in Table II below. The average control titer at time 0 was 8.4×10⁵ PFU for Samples 12-15, and 1.1×10⁶ for Samples 16-22, unless specified otherwise. Counts shown as approximate (˜) were taken from results where data was found outside the range of 25-250 PFU. Negative (−) percent reductions demonstrate an ending titer that was greater than the starting titer.

TABLE II

| Sample | Exposure | Recovered | Percent |
|---|---|---|---|
| ID | Interval (hrs.) | (PFU) | Reduction |
| 12 | 0 | 4.3 × 10⁵ | 48 |
| | 24 | 1.4 × 10⁵ | 83 |
| | 48 | ˜4.0 × 10⁴ | ˜95.2 |
| 13 | 0 | 8.4 × 10⁵ | 0 |
| | 24 | 2.8 × 10⁵ | 66 |
| | 48 | 2.5 × 10⁶ | −200 |
| 14 | 0 | 2.7 × 10⁵ | 68 |
| | 24 | 9.6 × 10⁴ | 88 |
| | 48 | 9.8 × 10⁵ | −17 |
| 15 | 0 | 7.9 × 10⁵ | 6 |
| | 24 | 1.0 × 10⁶ | −24 |
| | 48 | ˜1.3 × 10⁶ | −57 |
| 16 | 0 | 5.8 × 10⁵ | 47 |
| | 24 | 8.7 × 10⁵ | 20 |
| | 48 | 1.2 × 10⁶ | −13 |
| 17 | 0 | 7.2 × 10⁵ | 35 |
| | 24 | 9.0 × 10⁵ | 18 |
| | 48 | ˜4.0 × 10⁵ | ˜64 |
| 18 | 0 | 3.0 × 10⁵ | 72 |
| | 24 | 7.5 × 10⁵ | 31 |
| | 48 | 3.1 × 10⁵ | 72 |
| 19 | 0 | 2.1 × 10⁶ | −0.29 |
| | 24 | ˜8.2 × 10⁵ | ˜25 |
| | 48 | 1.1 × 10⁶ | 0 |
| 20 | 0 | 7.2 × 10⁵ | 34 |
| | 24 | 3.4 × 10⁵ | 69 |
| | 48 | 6.1 × 10⁵ | 45 |
| 21 | 0 | 1.0 × 10⁶ | 7 |
| | 24 | ˜4.5 × 10⁵ | ˜59 |
| | 48 | 2.9 × 10⁵ | 74 |
| 22 | 0 | 6.5 × 10⁵ | 41 |
| | 24 | 6.6 × 10⁵ | 40 |
| | 48 | 7.5 × 10⁵ | 32 |

Having described the invention in detail, those skilled in the art will appreciate that modification may be made to the various aspects of the invention without departing from the scope and spirit of the invention disclosed and described herein. It is, therefore, not intended that the scope of the invention be limited to the specific embodiments illustrated and described but rather it is intended that the scope of the present invention be determined by the appended claims and their equivalents. Moreover, all patents, patent applications, publications, and literature references presented herein are incorporated by reference in their entirety for any disclosure pertinent to the practice of this invention.

I claim:

1. An air filtration device comprising:
a. a layer of filter media; and
b. at least one prophylactic compound adjacent to said filter media.

2. The air filtration device of claim 1 wherein said filter media is selected from the group consisting of fibrous material, an open-celled foam or a porous membrane.

3. The air filtration device of claim 1 selected from the group consisting of personal filtration mask, furnace filter, air moving equipment filter, and breathing air compressor intake filter.

4. The air filtration device of claim 1 wherein said filter media is a non-woven material having a basis weight of from about 5 g/m² to about 1000 g/m².

5. The air filtration device of claim 1 wherein said filter media is a non-woven material having a basis weight of from about 20 g/m² to about 200 g/m².

6. The air filtration device of claim 1 wherein said filter media is a non-woven material electrostatically charged web.

7. The air filtration device of claim 1 wherein said prophylactic compound is selected from the group consisting of water soluble coenzymes; oil soluble coenzymes; amino acid type surfactants; a plant extract derived from Alium cepa; antibiotics; biocidal metals and metal containing compounds; organosilicone quaternary ammonium salts; sulfated polysaccharides; aliphatic and aromatic fatty acids having from 6 to 20 carbon atoms; cellulose and cellulose derivatives.

8. The air filtration device of claim 7 wherein said cellulose derivative is selected from the group consisting of cellulose having at least a partial substitution of the free hydroxyl functions with moieties selected from the formula —OYR wherein R is selected from: a) hydrocarbon groups with linear or branched chains, saturated or unsaturated, or saturated or unsaturated cyclic moieties, containing from 1 to 50 carbon atoms or b) cyclic aromatic compounds having from 6 to 14 carbon atoms that may be substituted with —(C═O)OR₂, —SO₂ R₂, —CO—N(R₂)₂, —OR₂, —N(R₂)₂, —SR₂, where R₂ is selected from the group consisting of hydrogen or linear, branched or cyclic hydrocarbon groups having from 1 to 50 carbon atoms; and Y is a single bond or divalent linking group wherein said divalent linking group is selected from the group consisting of —(C═O), —(C═O)O—, —SO₂—, —CO—NH—, and —CO—NR′—, wherein R′ is an alkyl radical having from 1 to 4 carbon atoms.

9. The air filtration device of claim 8 wherein R further comprises one or more aromatic groups and/or one or more heteroatoms selected from the group consisting of O, N, P, or S.

10. The air filtration device of claim 7 wherein said cellulose derivatives is selected from the group consisting of cellulose acetates, cellulose propionates, cellulose butyrates, cellulose isobutyrates, cellulose acetobutyrates, and cellulose acetopropionates.

11. The air filtration device of claim 7 wherein said cellulose derivatives is selected from the group consisting of cellulose acetate, cellulose acetate phthalate; hydroxypropyl methylcellulose phthalate and mixtures thereof.

12. The air filtration device of claim 7 wherein the amount of prophylactic compound incorporated into the filtration device is from about 0.001 to about 100 weight %, based on the total weight of the filter media and prophylactic compound.

13. The air filtration device of claim 7 wherein the amount of prophylactic compound incorporated into the filtration device is from about 0.01 to about 20 weight %, based on the total weight of the filter media and prophylactic compound.

14. The air filtration device of claim 7 wherein the amount of prophylactic compound incorporated into the filtration device is from about 0.1 to about 10 weight %, based on the total weight of the filter media and prophylactic compound.

15. The air filtration device of claim 1 wherein said prophylactic compound is a separate layer positioned before said filter media, relative to an air flow direction.

16. The air filtration device of claim 1 wherein said prophylactic compound is a separate layer positioned after said filter media, relative to an air flow direction.

17. The air filtration device of claim 1 wherein said prophylactic compound is deposited onto an outer surface of said filter media.

18. The air filtration device of claim 10 wherein said cellulose acetate phthalate and hydroxypropyl methylcellulose phthalate compounds are micronized.

19. The air filtration device of claim 1 further comprises a stiffening means attached to said filter media.

20. The air filtration device of claim 16 wherein said prophylactic compound is dispersed in a suitable solvent or aqueous media prior to depositing said prophylactic compound onto said outer surface of said filter media.

21. An air filtration device comprising:
a. a layer of filter media; and
b. at least one prophylactic compound selected from the group consisting of water soluble coenzymes; oil soluble coenzymes; amino acid type surfactants; a plant extract derived from Alium cepa; antibiotics; biocidal metals and metal containing compounds; organosilicone quaternary ammonium salts; sulfated polysaccharides; aliphatic and aromatic fatty acids having from 6 to 20 carbon atoms; cellulose acetate; cellulose acetate phthalate; hydroxypropyl methylcellulose phthalate and mixtures thereof adjacent to the filter media.

22. The air filtration device of claim 21 wherein said filter media is a non-woven material having a basis weight of from about 20 g/m² to about 200 g/m².

23. The air filtration device of claim 21 wherein said filter media is a non-woven material electrostatically charged web.

24. The air filtration device of claim 21 wherein the amount of prophylactic compound incorporated into the filtration device is from about 0.001 to about 100 weight %, based on the total weight of the filter media and prophylactic compound.

25. The air filtration device of claim 21 wherein the amount of prophylactic compound incorporated into the filtration device is from about 0.1 to about 10 weight %, based on the total weight of the filter media and prophylactic compound.

26. The air filtration device of claim 21 wherein said prophylactic compound is a separate layer positioned before said filter media, relative to an air flow direction.

27. The air filtration device of claim 21 wherein said prophylactic compound is deposited onto an outer surface of said filter media.

28. The air filtration device of claim 21 wherein said cellulose acetate phthalate and hydroxypropyl methylcellulose phthalate compounds are micronized.

29. An air filtration device comprising:
a. a layer of filter media; and
b. at least one prophylactic compound selected from the group consisting of cellulose acetate; cellulose acetate phthalate; hydroxypropyl methylcellulose phthalate and mixtures thereof adjacent to said filter media.

30. The air filtration device of claim 29 wherein said filter media is a non-woven material having a basis weight of from about 20 g/m² to about 200 g/m².

31. The air filtration device of claim 29 wherein said filter media is a non-woven material electrostatically charged web.

32. The air filtration device of claim 29 wherein the amount of prophylactic compound incorporated into the filtration device is from about 0.001 to about 100 weight %, based on the total weight of the filter media and prophylactic compound.

33. The air filtration device of claim 29 wherein the amount of prophylactic compound incorporated into the filtration device is from about 0.1 to about 10 weight %, based on the total weight of the filter media and prophylactic compound.

34. The air filtration device of claim 29 wherein said prophylactic compound is a separate layer.

35. The air filtration device of claim 34 wherein said separate layer has a basis weight of from about 5 g/m² to about 50 g/m² and is positioned after said filter media, relative to an air flow direction.

36. The air filtration device of claim 31 wherein said prophylactic compound is deposited onto an outer surface of said filter media.

37. The air filtration device of claim 34 wherein said prophylactic compound is cellulose acetate phthalate and further comprises a plasticizer selected from the group consisting of aceylated monoglyceride, butyl phthalylbutyl glycolate, dibutyl tartrate; diethyl phthalate, dimethyl phthalate, ethyl phthalyethyl glycolate, glycerin, propylene glycol, triacetin, triacetin citrate, tripropionin and mixtures thereof.

38. An air filtration device comprising a prophylactic compound.

39. The air filtration device of claim 38 wherein said prophylactic compound is a fiber.

40. The air filtration device of claim 39 wherein said prophylactic fiber comprises from 0.001 to 100% of said filter media.

41. The air filtration device of claim 38 wherein said prophylactic compound is a particle.

42. The air filtration device of claim 39 wherein said prophylactic fiber comprises a fiber selected from the group consisting of cellulose acetate, cellulose acetate phthalate; hydroxypropyl methylcellulose phthalate and mixtures thereof.

43. A method for reducing an amount of bacteria in a fluid stream comprising:
a. providing a filter device comprising a prophylactic compound; and
b. passing the fluid stream through said filter device.

44. The process of claim 43 further comprising recirculating at least a portion of the fluid stream through the filter device.
